(19) United States
(12) Patent Application Publication
(10) Pub. No.: US 2013/0187907 A1
(43) Pub. Date: Jul. 25, 2013

(54) IMAGE PROCESSING APPARATUS, IMAGE PROCESSING METHOD, AND PROGRAM

(71) Applicant: Sony Corporation, Tokyo (JP)

(72) Inventor: Kiyoto Someya, Tokyo (JP)

(73) Assignee: Sony Corporation, Tokyo (JP)

(21) Appl. No.: 13/742,547

(22) Filed: Jan. 16, 2013

(30) Foreign Application Priority Data
Jan. 23, 2012 (JP) 2012-011063

(51) Int. Cl. G06T 15/00

(52) U.S. Cl. CPC G06T 15/00
USPC 345/419

(57) ABSTRACT

An image processing apparatus includes an information obtaining unit configured to obtain parallax adjustment information with regard to a parallax-adjusted three-dimensional display material and an image transform unit configured to perform an inverse transform processing on the parallax-adjusted three-dimensional display material to be restored to a material before the parallax adjustment on the basis of the parallax adjustment information obtained by the information obtaining unit and generate a two-dimensional display material.

### BACKGROUND

The present technology relates to an image processing apparatus, an image processing method, and a program. In particular, a three-dimensional display and a two-dimensional display are to be carried out naturally and more comfortably.

In recent years, an image display apparatus is provided with a function of carrying out a three-dimensional display. When a three-dimensional image displayed by the above-mentioned image display apparatus is viewed, a focal distance varies even when an angle of convergence is the same as the real world, which becomes a cause of visual fatigue. In particular, if a change of parallax is large, for example, in a case where a certain part on a screen protrudes too much or a case where an object suddenly jumps out during a movie display, a viewer is strained. For this reason, to reduce the strain of the viewer and display the three-dimensional image naturally and more comfortably, a technology of shifting the image in a horizontal direction to adjust the parallax is proposed (for example, see Japanese Unexamined Patent Application Publication No. 2011-055022).

### SUMMARY

Incidentally, when a two-dimensional display is carried out by using the three-dimensional display material where the parallax is adjusted through the horizontal shift, a movement based on the parallax adjustment may be generated in the displayed image in some cases. For example, in a case where both a still object and a moving object exist on the screen, if a depth of the moving object is largely changed, the image is shifted in the horizontal direction so as to display the three-dimensional image naturally and more comfortably. For this reason, the still object is also moved through the shift of the image in the horizontal direction. Consequently, when the two-dimensional display is carried out by using the parallax-adjusted three-dimensional display material, the still object is displayed with a movement in accordance with the change in the depth of the moving object.

In view of the above, according to an embodiment of this technology, it is desirable to provide an image processing apparatus and an image processing method, and a program with which a three-dimensional display and a two-dimensional display can be carried out naturally and more comfortably.

According to an embodiment of this technology, there is provided an image processing apparatus including: an information obtaining unit configured to obtain parallax adjustment information with regard to a parallax-adjusted three-dimensional display material; and an image transform unit configured to generate a material before the parallax adjustment as a two-dimensional display material from the parallax-adjusted three-dimensional display material on the basis of the parallax adjustment information obtained by the information obtaining unit.

According to the embodiment of this technology, the parallax adjustment information with regard to the parallax-adjusted three-dimensional display material is obtained, and the inverse transform processing is conducted on the parallax-adjusted three-dimensional display material to be restored to the material before the parallax adjustment on the basis of this parallax adjustment information to generate the two-dimensional display material. For example, in a case where an entire image is shifted in the parallax adjustment, the entire image may be shifted in an opposite direction in the inverse transform processing. Also, in a case where an object is shifted in the parallax adjustment, the object may be shifted in the opposite direction in the inverse transform processing.

Also, in the inverse transform processing, an image may be enlarged, or an interpolation processing may be conducted on an area where the image does not exist to eliminate the area without the existence of the image through the inverse transform processing. In a case where the image is enlarged, the image may be enlarged in accordance with an adjustment amount of the parallax adjustment to eliminate the area without the existence of the image. Alternatively, the image may be enlarged in accordance with a maximum adjustment amount of the parallax adjustment to eliminate the area without the existence of the image. Alternatively, the image may be enlarged in accordance with a maximum adjustment amount of the parallax adjustment for each scene to eliminate the area without the existence of the image.

Furthermore, identification information indicating whether or not the three-dimensional display material is the parallax-adjusted material may be obtained, and in a case where a three-dimensional display is carried out, when the identification information obtained by the information obtaining unit indicates that the parallax adjustment is not conducted, the parallax adjustment may be conducted.

According to another embodiment of this technology, there is provided an image processing method including:

obtaining parallax adjustment information with regard to a parallax-adjusted three-dimensional display material; and performing an inverse transform processing on the parallax-adjusted three-dimensional display material to be restored to a material before the parallax adjustment on the basis of the obtained parallax adjustment information and generating a two-dimensional display material.

According to still another embodiment of this technology, there is provided a program for causing a computer to execute an image processing on a three-dimensional display material, the image processing including: obtaining parallax adjustment information with regard to a parallax-adjusted three-dimensional display material; and performing an inverse transform processing on the parallax-adjusted three-dimensional display material to be restored to a material before the parallax adjustment on the basis of the obtained parallax adjustment information and generating a two-dimensional display material.

It should be noted that the program according to the embodiment of the present technology is a program that can be provided, for example, to a general-use computer that can execute various program codes by a storage medium or a communication medium in a computer-readable format, for example, a storage medium such as an optical disc, a magnetic disc, or a semiconductor memory or a communication medium such as a network. By providing the above-mentioned program in the computer-readable format, the processing in accordance with the program is realized on the computer.

According to the embodiment of this technology, the parallax adjustment information with regard to the parallax-adjusted three-dimensional display material is obtained, and on the basis of this obtained parallax adjustment information, the material before the parallax adjustment is conducted is generated as the two-dimensional display material from the parallax-adjusted three-dimensional display material. For this reason, in the two-dimensional display, the movement of the still object caused by the parallax adjustment can be avoided during the display, and the three-dimensional display and the two-dimensional display can be carried out naturally and more comfortably.

### BRIEF DESCRIPTION OF THE DRAWINGS

FIG. 1 is an explanatory diagram for describing a relationship between a parallax and a distance to a three-dimensional image;

FIG. 2 illustrates a manner of a shift processing;

FIG. 3 is a graphic representation illustrating a relationship among changes in a three-dimensional image distance;

FIG. 4 is an explanatory diagram for describing a comfortable range of a three-dimensional vision;

FIG. 5 exemplifies a configuration of an image processing apparatus;

FIG. 6 is a flow chart exemplifying a first operation by the image processing apparatus;

FIG. 7 exemplifies the first operation by the image processing apparatus;

FIGS. 8A to 8D are explanatory diagrams for describing an interpolation of an image;

FIGS. 9A to 9D exemplify an operation in a case where an enlargement of the image is conducted.

FIG. 10 is a flow chart examplifying a second operation by the image processing apparatus;

FIG. 11 exemplifies a case where a material before a parallax adjustment is recorded in a recording medium in the second operation by the image processing apparatus; and

FIG. 12 exemplifies a configuration of a computer apparatus.

### DETAILED DESCRIPTION OF EMBODIMENTS

Hereinafter, embodiments for carrying out the present technology will be described. It should be noted that the description will be given in the following order.

1. Regarding parallax adjustment
2. Configuration and operation according to embodiment

2-1. Configuration of image processing apparatus

2-2. First operation by image processing apparatus

2-3. Second operation by image processing apparatus

3. Case of software processing
1. Regarding parallax adjustment

First, a parallax adjustment will be described. A pixel at coordinates (x, y) is set as p(x, y), attention pixels on left and right images are set as p(x_{L}, y_{L}) and p(x_{R}, y_{R}), and pixels on the left and right images after a parallax control are set as p(x′_{L}, y′_{L}) and p(x′_{R}, y′_{R}). Herein, in an image transform for a parallax adjustment, a shift processing of shifting relative positions of the left and right images is defined as Expression (1). At this time, a parallax control parameter is a shift amount s.

$$( \begin{matrix}{x}_{L}^{′} & {x}_{R}^{′} \\ {y}_{L}^{′} & {y}_{R}^{′}\end{matrix} ) = ( \begin{matrix}{x}_{L} - \frac{s}{2} & {x}_{R} + \frac{s}{2} \\ {y}_{L} & {y}_{R}\end{matrix} ) \qquad ( 1 )$$

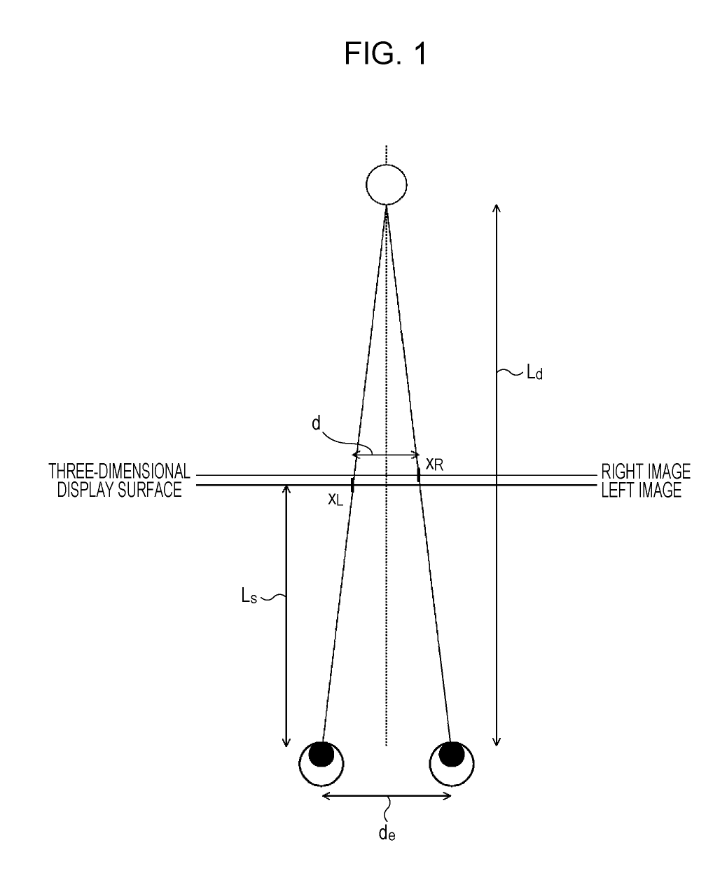

FIG. 1 is an explanatory diagram for describing a relationship between a parallax and a distance to a three-dimensional image. In FIG. 1, a space between a left eye and a right eye is set as an interocular interval dₑ, a distance from a center between the left eye and the right eye to a display surface of a three-dimensional display is set as a sight distance Lₛ, and a distance from the center between the left eye and the right eye to the three-dimensional image is set as a three-dimensional image distance L_{d}. In addition, a horizontal coordinate on the display surface of the left image is set as x_{L}, and a horizontal coordinate on the display surface of the right image is set as x_{R}. At this time, a parallax d is defined as a relative distance between x_{L} and x_{R} as represented by Expression (2).

d=x_{R}−x_{L} (2)

That is, in a case where the three-dimensional image exists in back of the display surface of the three-dimensional display, the parallax d is a positive number, and in a case where the three-dimensional image exists in front of the display surface of the three-dimensional display, the parallax d is a negative number.

Also, in FIG. 1, a ratio of the three-dimensional image distance L_{d} and the sight distance Lₛ can be calculated from Expression (3) by using the interocular interval dₑ and the parallax d. Furthermore, the three-dimensional image distance L_{d} can be represented by Expression (4).

L_{d}:Lₛ=dₑ:(dₑ−d) (3)

L_{d}=Lₛ·dₑ/(dₑ−d) (4)

Herein, when a consideration is given while the interocular interval dₑ and the sight distance Lₛ are set as fixed values, the three-dimensional image distance L_{d} depends on the parallax d as represented by Expression (4). That is, it may be apparent that a three-dimensional appearance (three-dimensional image distance L_{d}) changes depending on the parallax d.

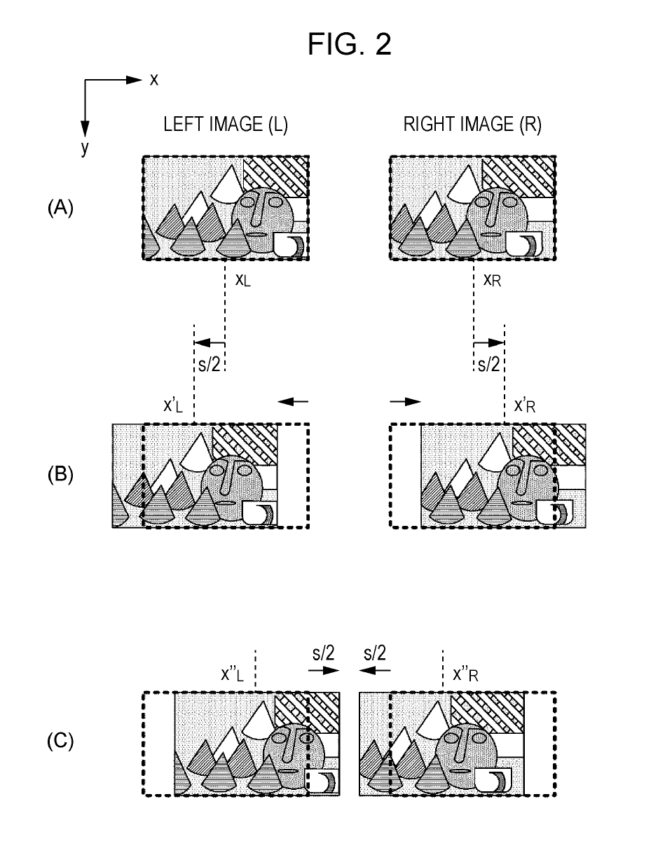

FIG. 2 illustrates a manner of a shift processing.

(A) of FIG. 2 illustrates the left and right images at the time of the shift amount s=0, that is, the images in a state in which the shift processing is not conducted. A coordinate of the target pixel in the horizontal (x) direction of the left image (left view point material) is set as x_{L}, and a coordinate of the target pixel in the horizontal direction of the right image (right view point material) is set as x_{R}.

(B) of FIG. 2 illustrates the left and right images at the time of the shift amount s>0, that is, the images in a state in which the shift processing is conducted in a direction in which the left and right images are separated from each other. In order that the coordinate of the target pixel in the left image is changed from x_{L} to x′_{L}, the left image is shifted in the left direction by s/2 pixels. On the other hand, in order that the coordinate of the target pixel in the right image is changed from x_{R} to X′_{R}, the right image is shifted in the right direction by s/2 pixels. That is, the left and right images are respectively shifted by s/2 pixels each, in total, by s pixels.

(C) of FIG. 2 illustrates the left and right images at the time of the shift amount s<0, that is, the images in a state in which the shift processing is conducted in a direction in which the left and right images are coming closer to each other. In order that the coordinate of the target pixel in the left image is changed from x_{L} to x″_{L}, the left image is shifted in the right direction by s/2 pixels. On the other hand, in order that the coordinate of the target pixel in the right image is changed from x_{R} to x″_{R}, the right image is shifted in the left direction by s/2 pixels. That is, the left and right images are respectively shifted by s/2 pixels each, in total, by s pixels.

Herein, when the pixel at the coordinates (x, y) is set as p(x, y) and the target pixels on the left and right images are set as p(x_{L}, y_{L}) and p(x_{R}, y_{R}), the pixels p(x′_{L}, y′_{L}) and p(x′_{R}, y′_{R}) on the left and right images after the parallax adjustment by the shift amount s can be calculated from Expressions (5) and (6).

p(x′_{L},y′_{L})=p(x_{L}−s/2,y_{L}) (5)

p(x′_{R},y′_{R})=p(x_{R}+s/2,y_{R}) (6)

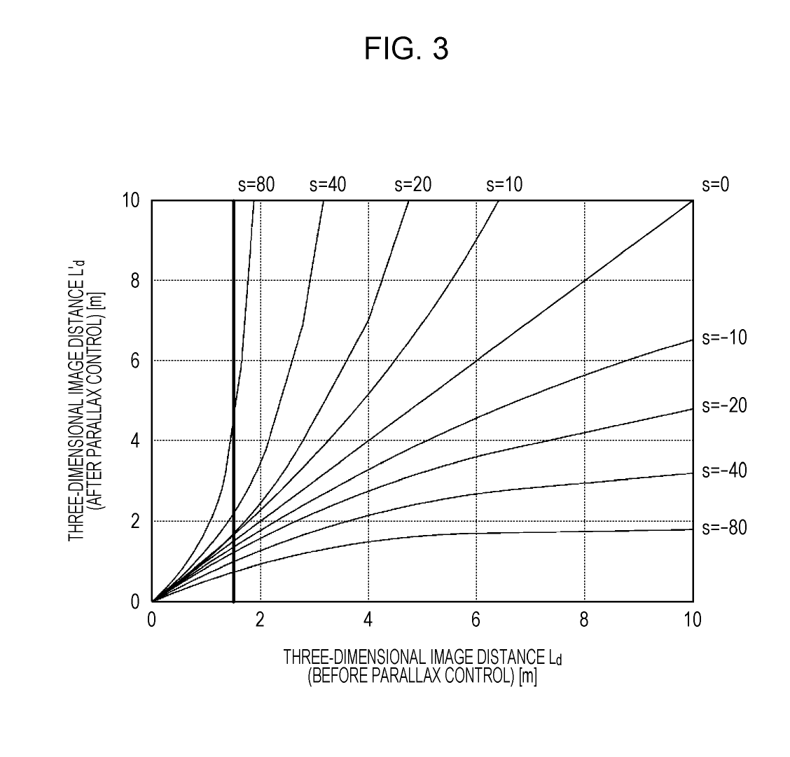

FIG. 3 is a graphic representation illustrating a relationship among changes in the three-dimensional image distance. A vertical bold line indicates a position of the display surface of the three-dimensional display, and herein, for example, 1.5 [m] is supposed.

In a case where the shift processing is conducted by the shift amount s, since the parallax changes to (d+s), a three-dimensional image distance L′_{d} after the shift processing is represented by Expression (7).

L′_{d}=Lₛ·dₑ/(dₑ−(d+s)) (7)

That is, in a case where the shift processing is conducted in the direction in which the left and right images are separated from each other (s>0), it is perceived that the three-dimensional image is further moved into the back. At this time, as the shift amount is increased, it is perceived that the three-dimensional image is further moved into the back, and the object further in the back is moved more into the back. On the other hand, in a case where the shift processing is conducted in the direction in which the left and right images are coming closer to each other (s<0), it is perceived that the three-dimensional image is further moved towards the front. At this time, as an absolute value of the shift amount is increased, it is perceived that the three-dimensional image is further moved towards the front, and the object further in the back is moved towards the front more.

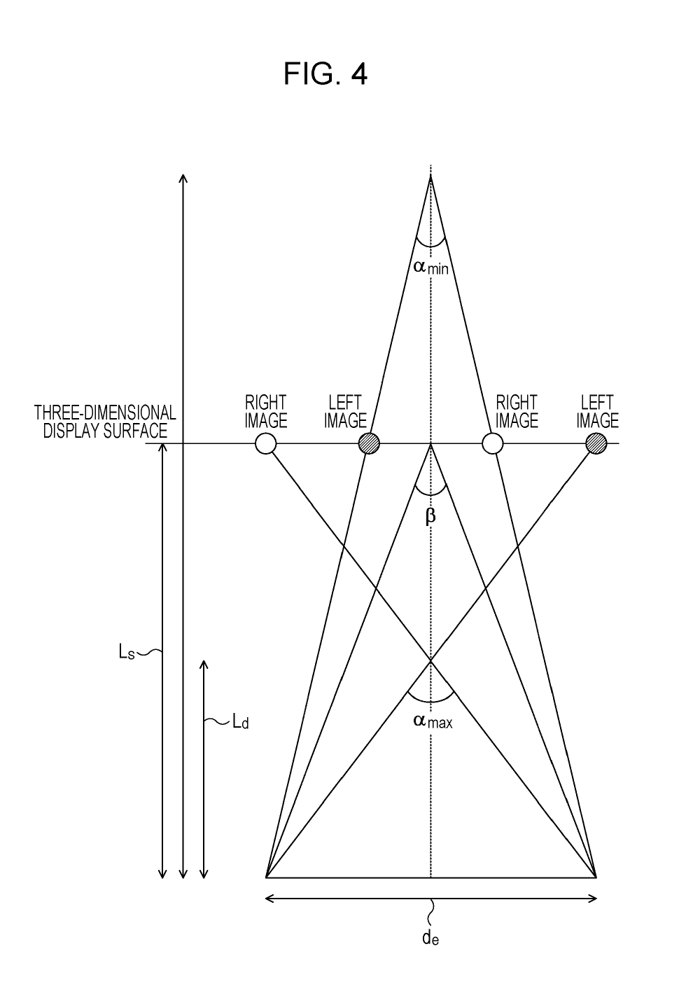

Also, it is conceivable that a comfortable range of a three-dimensional vision is a range of a parallax angle at ±1° from a parallax angle on the display surface of the three-dimensional display. FIG. 4 is an explanatory diagram for describing the comfortable range of the three-dimensional vision. Herein, the interocular interval dₑ, the sight distance Lₛ, and the three-dimensional image distance L_{d} are used, and a parallax angle on the display surface of the three-dimensional display is set as a parallax angle β. In this case, when the parallax angle at ±1° is represented as α, a relationship between the parallax angle α and the parallax angle β is represented by Expression (8). That is, the parallax angle α corresponds to an angle indicated by Expression (9).

|α−β|≦1°(=π/180) (8)

α=β±(π/180) (9)

A relationship between the sight distance Lₛ and the parallax angle β corresponds to Expression (10). Therefore, the parallax angle β can be calculated from Expression (11).

(dₑ/2)/Lₛ=tan(β/2) (10)

β=2 tan−1(dₑ/(2Lₛ)) (11)

Furthermore, a relationship between the three-dimensional image distance L_{d} and α corresponds to Expression (12).

L_{d}=dₑ/2 tan(α/2) (12)

Therefore, the range in the depth direction where the viewing can be comfortably conducted corresponds to Expression (13).

dₑ/2 tan(αₘₐₓ/2) to dₑ/2 tan(αₘᵢₙ/2) (13)

It should be noted that parallax angles αₘₐₓ and αₘᵢₙ correspond to values in Expressions (14) and (15).

αₘₐₓ=β+π/180 (14)

αₘᵢₙ=β−π/180 (15)

In this manner, when the shift amount s is adjusted so that the three-dimensional image distance L_{d} falls within the range indicated by Expression (13), the change in the parallax is suppressed, and the comfortable viewing can be carried out.

Also, in the above-mentioned parallax adjustment, the case has been described in which the left and right images are shifted in the horizontal direction, but the parallax adjustment may be carried out in units of object. For example, by using an image pickup element provided with a ranging function, it is possible to detect distances to respective objects included in an image pickup range. Therefore, the parallax adjustment may also be carried out in units of object on the basis of the ranging results of the respective objects. In addition, parallax amounts with regard to the respective objects are determined from the left and right images through an image processing, and the parallax adjustment may also be carried out in units of object on the basis of the determination results.

### 2. Configuration and Operation According to Embodiment

When the two-dimensional display is carried out by using the three-dimensional display material where the parallax adjustment for shifting the image in accordance with the three-dimensional image distance is conducted in order that the comfortable viewing of the three-dimensional image can be carried out, the still object is caused to make a movement because of an influence from the transform processing. In view of the above, according to this technology, in a case where the two-dimensional display is carried out by using the three-dimensional display material after the parallax adjustment, a display material before the parallax adjustment is generated on the basis of the parallax adjustment information with regard to the parallax-adjusted three-dimensional display material to be used as the two-dimensional display material.

2-1. Configuration of Image Processing Apparatus

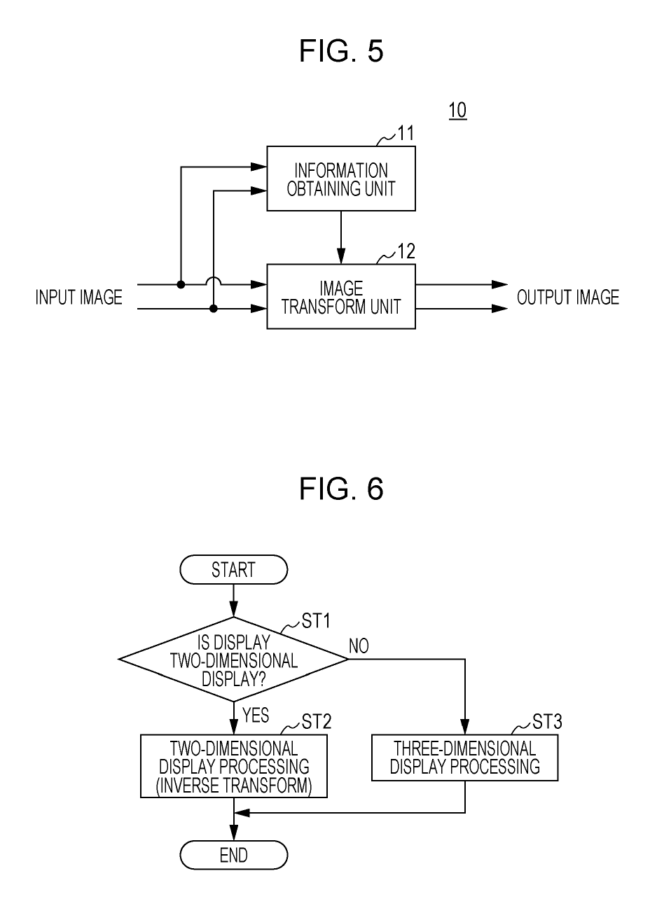

FIG. 5 exemplifies a configuration of an image processing apparatus. An image processing apparatus 10 includes an information obtaining unit 11 and an image transform unit 12.

The information obtaining unit 11 obtains the parallax adjustment information with regard to the three-dimensional display material after the parallax adjustment which is used for the two-dimensional display. For example, in a stream of image data generated by using an encoding system such as H.264/AVC or HEVC, SEI (Supplemental enhancement information) indicating additional information is provided as a syntax element. In a case where parallax adjustment information indicating the shift amount of the horizontal shift is included in this SEI, the information obtaining unit 11 obtains the parallax information from the SEI of the stream. Also, in a case where the parallax adjustment information is filed in a separated manner from the three-dimensional display material, the parallax information is obtained from a file corresponding to the three-dimensional display material used for the two-dimensional display. It should be noted that, for example, in a case where the parallax adjustment is conducted in units of frame, the parallax adjustment information indicates the shift amount of the horizontal shift carried out for each frame, and in a case where the parallax adjustment is conducted in units of GOP (Group Of Pictures), the parallax adjustment information indicates the shift amount of the horizontal shift carried out for each GOP. The information obtaining unit 11 outputs the obtained parallax adjustment information to the image transform unit 12.

The image transform unit 12 performs an inverse transform processing on the parallax-adjusted three-dimensional display material to be restored to a material before the parallax adjustment on the basis of the parallax adjustment information. Herein, the pixel at the coordinates (x, y) is set as p(x, y), the target pixels on the left and right images are set as p(x_{L}, y_{L}) and p(x_{R}, y_{R}), and the pixels on the left and right images after the parallax adjustment are set as p(x′_{L}, y′_{L}) and p(x′_{R}, y′_{R}). In the parallax adjustment, the processing of shifting the relative positions of the left and right images in the horizontal direction is defined as Expression (1). In this case, the parallax adjustment information indicates the shift amount s. On the basis of the parallax adjustment information, in an inverse manner to Expression (1), the image transform unit 12 calculates the target pixels p(x_{L}, y_{L}) and p(x_{R}, y_{R}) on the left and right images before the parallax adjustment from the pixels p(x′_{L}, y′_{L}) and p(x′_{R}, y′_{R}) on the left and right images after the parallax adjustment to generate the material before the parallax adjustment. Also, the image transform unit 12 outputs the material generated through the inverse transform processing, that is, one of a left view point material and a right view point material before the parallax adjustment as the two-dimensional display material.

When the image transform unit 12 performs the horizontal shift on an entire image in the opposite direction to the direction at the time of the parallax adjustment in the inverse transform processing, an area where the image does not exist is generated on one of the left end and the right end of the image. Therefore, the image transform unit 12 performs an image interpolation processing with respect to the area where the image does not exist. The image transform unit 12 sets the area where the image does not exist, for example, as a black strip display for the image interpolation processing. Also, the image transform unit 12 may perform an image enlargement processing to avoid the generation of the area where the image does not exist for the image interpolation processing. Furthermore, the image transform unit 12 may perform the interpolation of the area where the image does not exist by utilizing an image of a different view point or an image at a different time for the image interpolation processing.

When the image transform unit 12 performs the horizontal shift on an object in the image in the opposite direction to the direction at the time of the parallax adjustment in the inverse transform processing, it is assumed that an area where the image does not exist on an object border (occlusion area) may be generated. Therefore, the image transform unit 12 performs the image interpolation processing on the occlusion area. The image transform unit 12 interpolates the occlusion area by utilizing an image of a different view point or an image at a different time for the image interpolation processing.

Furthermore, in the inverse transform processing, the image transform unit 12 may perform the image enlargement processing so that the area where the image does not exist is not generated even when the horizontal shift is conducted.

2-2. First Operation by Image Processing Apparatus

In a first operation by the image processing apparatus 10, an operation in a case where the image display is carried out by using the material on which the horizontal shift processing is conducted will be described.

FIG. 6 is a flow chart exemplifying the first operation by the image processing apparatus. In step ST1, the image transform unit 12 determines whether or not the two-dimensional display is carried out. In a case where the two-dimensional display is carried out, for example, in a case where the two-dimensional display is instructed from a user or a case where the display apparatus used for the image display does not have a three-dimensional display function, the image transform unit 12 proceeds to step ST2. Also, for example, in a case where the three-dimensional display is instructed from the user or a case where the display apparatus has the three-dimensional display function, the image transform unit 12 proceeds to step ST3.

In step ST2, the image transform unit 12 performs the two-dimensional display processing. The image transform unit 12 performs the inverse transform processing on the basis of the parallax adjustment information supplied from the information obtaining unit 11 and generates the material before the parallax adjustment from the three-dimensional display material after the parallax adjustment. Furthermore, the image transform unit 12 outputs the generated material before the parallax adjustment, for example, one of the left view point material and the right view point material as the two-dimensional display material.

In step ST3, the image transform unit 12 performs the three-dimensional display processing. The image transform unit 12 outputs the three-dimensional display material after the parallax adjustment.

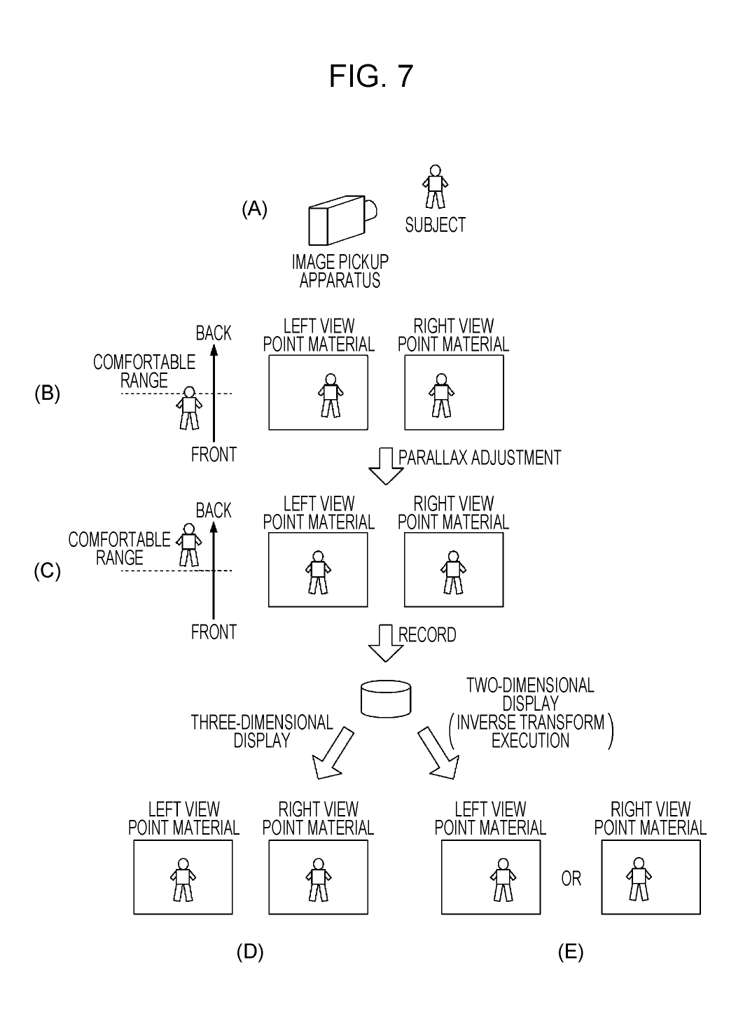

FIG. 7 exemplifies the first operation by the image processing apparatus. For example, as illustrated in (A) of FIG. 7, an image of a subject is picked up by an image pickup apparatus. Herein, as illustrated in (B) of FIG. 7, in a case where a subject position is located in front of a comfortable range, the parallax adjustment is conducted on the left view point material and the right view point material, and as illustrated in (C) of FIG. 7, the position of the subject is moved. By conducting the parallax adjustment in the above-mentioned manner, the subject position is set to be located within the comfortable range. The left view point material and the right view point material where the parallax adjustment is conducted are recorded, for example, in a recording medium. In a case where a three-dimensional display is carried out by using the recoded left view point material and the right view point material, as illustrated in (D) of FIG. 7, the left image is displayed by using the recoded left view point material, and the right image is displayed by using the recoded right view point material. Also, in a case where the two-dimensional display is carried out, as illustrated in (E) of FIG. 7, the inverse transform processing is conducted on one of the recorded left view point material and the recorded right view point material after the parallax adjustment to generate the material before the parallax adjustment. The two-dimensional display is carried out by using this generated material.

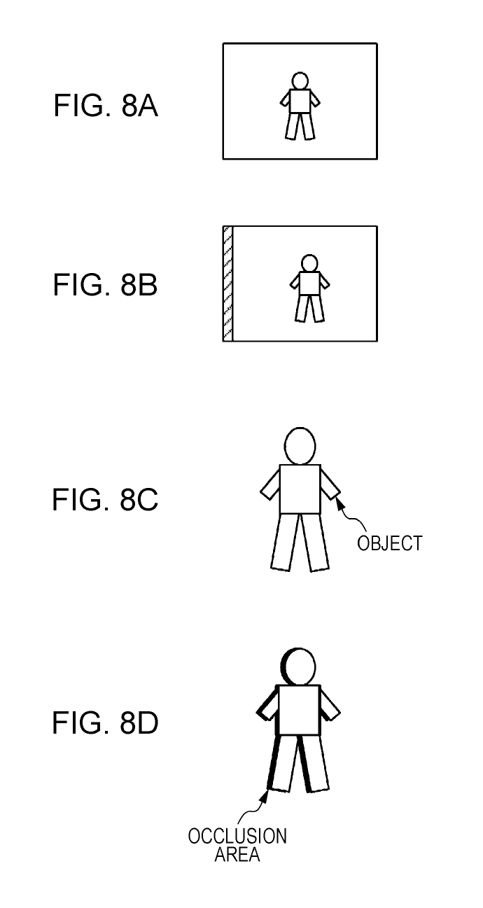

When the horizontal shift is conducted in the opposite direction to the direction at the time of the parallax adjustment through the inverse transform processing, the area where the image does not exist is generated. Therefore, in the inverse transform processing, the interpolation is conducted with respect to the area where the image does not exist. FIGS. 8A to 8D are explanatory diagrams for describing the interpolation of the image. For example, a material illustrated in FIG. 8A is horizontally shifted in the right direction as illustrated in FIG. 8B, and an area where the image does not exist is generated on the left side end as represented by a shaded portion. Therefore, the image transform unit 12 sets the area where the image does not exist, for example, as the black strip display for the image interpolation processing. Also, the image on the left side end may be copied in the horizontal direction.

Also, in a case where the parallax adjustment for each object is conducted, for example, an object illustrated in FIG. 8C is horizontally shifted in the right direction as illustrated in FIG. 8D, and the occlusion area where the image does not exist may be generated as represented by black on an object border in some cases. Therefore, the image transform unit 12 performs the interpolation of the occlusion area by utilizing an image of a different view point or an image at a different time for the image interpolation processing.

Furthermore, the image transform unit may avoid the generation of the area where the image does not exist by enlarging the image. In a case where the image enlargement is conducted, the image transform unit 12 sets an enlargement factor in accordance with the shift amount. For example, by increasing the enlargement factor as the shift amount is higher, it is possible to eliminate the area where the image does not exist. Also, if the enlargement factor does not suddenly fluctuate, the user regards the image enlargement as an effect added at the time of editing or the like, it is possible to avoid a reaction that the image involves a sense of discomfort.

In addition, the image transform unit 12 may decide the enlargement factor in accordance with a maximum shift amount. In this case, the area where the image does not exist can be eliminated, and also the image size is unchanged even when the shift amount is changed. The maximum shift amount may previously be set as a maximum amount of the shift amount at the time of the generation of the three-dimensional display material, and also the maximum shift amount may be stored at the time of the generation of the three-dimensional display material. Furthermore, the enlargement factor may be decided in accordance with the maximum shift amount in units of scene as well as in units of material of the three-dimensional display material.

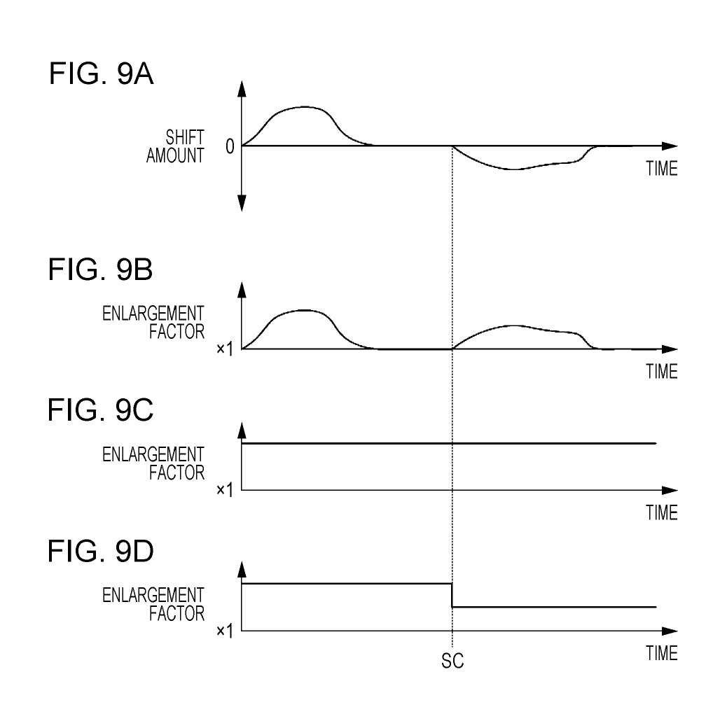

FIGS. 9A to 9D exemplify an operation in a case where an enlargement of the image is conducted. FIG. 9A exemplifies a change in the shift amount at the time of the image pickup. FIG. 9B illustrates a case in which the enlargement factor is set in accordance with the shift amount. As illustrated in FIG. 9B, by increasing the enlargement factor as an absolute value of the shift amount is higher, it is possible to eliminate the area where the image does not exist. FIG. 9C illustrates a case in which the enlargement factor is set in accordance with the maximum shift amount. In this case, not only the area where the image does not exist can be eliminated, but also even when the shift amount is changed, the image size is unchanged. FIG. 9D illustrates a case in which the enlargement factor is set in accordance with the maximum shift amount in units of scene. It should be noted that in FIGS. 9A to 9D, a scene switching location is indicated as a scene change location SC. In this case, the unwanted enlargement of the image is not conducted.

Also, in a case where the parallax adjustment is conducted in units of GOP (Group Of Pictures) and the parallax adjustment information indicates the shift amount conducted for each GOP, the image transform unit 12 performs the inverse transform processing on the basis of the parallax adjustment information and generates the material before the parallax adjustment in units of GOP. In addition, in a case where the parallax adjustment is conducted in units of frame and the parallax adjustment information indicates the shift amount in units of GOP, a linear interpolation is conducted by using the shift amount that is indicated by the parallax adjustment information corresponding to at least one of proceeding and subsequent GOPs to calculate the shift amounts of the respective frames in the GOP. The inverse transform processing may be conducted on the respective frames by using this calculated shift amount to generate the material before the parallax adjustment.

As described above, in a case where the three-dimensional display is carried out, since the parallax-adjusted three-dimensional display material is output, if the three-dimensional display is carried out by using the image data that is output from the image processing apparatus 10, it is possible to display the three-dimensional image more naturally and comfortably. Also, in a case where the two-dimensional display is carried out, one of the left view point material and the right view point material is output which corresponds to the material before the parallax adjustment generated by conducting the inverse transform processing on the three-dimensional display material after the parallax adjustment on the basis of the parallax adjustment information. Therefore, even when the parallax-adjusted three-dimensional display material is used, it is possible to avoid the display of the object that is still in the two-dimensional display without the movement. Also, since the image interpolation processing is conducted in the two-dimensional display, it is possible to eliminate the area without the existence of the image. It should be noted that in a case where the parallax adjustment is conducted by switching to or selecting the entire image or the units of object, the information indicating whether the parallax adjustment is conducted by selecting the entire image or the units of object and the information on the object on which the parallax adjustment is conducted are included in the parallax adjustment information.

2-3. Second Operation by Image Processing Apparatus

Incidentally, in the first operation, the operation in a case where the image display is carried out by using the three-dimensional display material after the parallax adjustment has been described. In the image processing apparatus 10, not only the three-dimensional display material after the parallax adjustment but also the three-dimensional display material before the parallax adjustment may be utilized. In a second operation, a case in which both the three-dimensional display material before the parallax adjustment and the three-dimensional display material after the parallax adjustment can be utilized will be described. It should be noted that the material used by the image processing apparatus 10 has identification information indicating whether or not the three-dimensional display material is a material where the parallax adjustment is conducted. The identification information is provided, for example, as a flag in a header of the three-dimensional display material. Herein, in a case where the flag is “0”, the three-dimensional display material is a material where the parallax adjustment is not conducted. On the other hand, in a case where the flag is “1”, the three-dimensional display material is the material where the parallax adjustment is conducted. Also, in a case where the flag is “1”, the parallax adjustment information indicating an adjustment amount for the parallax adjustment is provided.

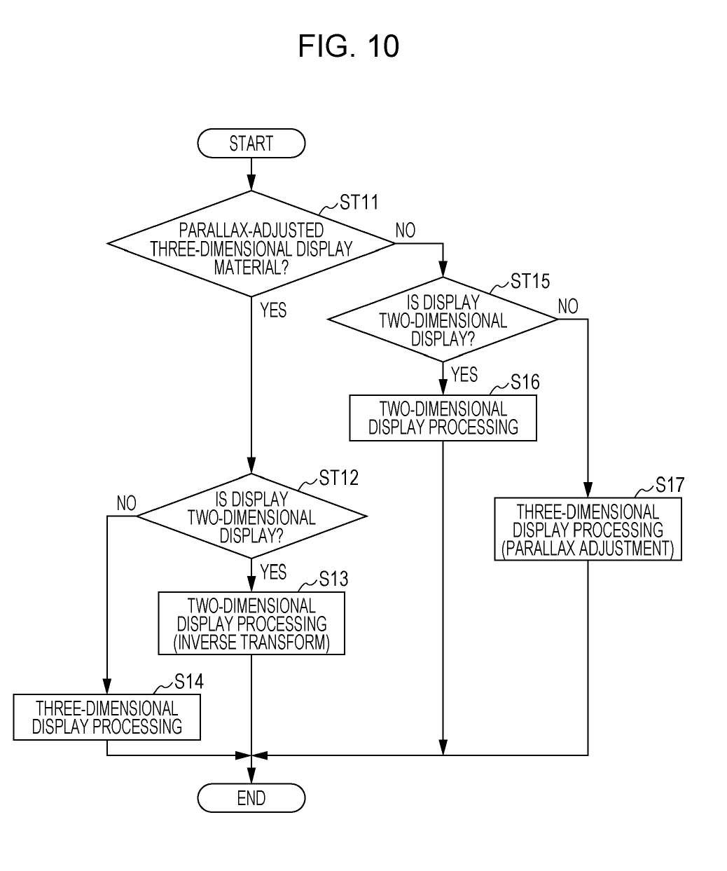

FIG. 10 exemplifies the second operation by the image processing apparatus. In step ST11, the image transform unit 12 determines whether or not the parallax adjustment is the three-dimensional display material. On the basis of the identification information, in a case where it is determined that the three-dimensional display material is the parallax-adjusted material, the image transform unit 12 proceeds to step ST12, and in a case where it is not determined that the three-dimensional display material is the parallax-adjusted material, the image transform unit 12 proceeds to step ST15.

In step ST12, the image transform unit 12 determines whether or not the two-dimensional display is carried out. In a case where the two-dimensional display is carried out, for example, in a case where the two-dimensional display is instructed from the user or a case where the display apparatus used for the image display does not have the three-dimensional display function, the image transform unit 12 proceeds to step ST13. Also, for example, in a case where the three-dimensional display is instructed from the user or a case where the display apparatus has the three-dimensional display function, the image transform unit 12 proceeds to step ST14.

In step ST13, the image transform unit 12 performs the two-dimensional display processing. The image transform unit 12 performs the inverse transform processing on the basis of the parallax adjustment information supplied from the information obtaining unit 11 and generates the material before the parallax adjustment from the three-dimensional display material after the parallax adjustment. Furthermore, the image transform unit 12 outputs one of the left view point material and the right view point material corresponding to the generated material before the parallax adjustment as the two-dimensional display material.

In step ST14, the image transform unit 12 performs the three-dimensional display processing. The image transform unit 12 outputs the three-dimensional display material after the parallax adjustment.

When the image transform unit 12 proceeds from step ST11 to step ST15, the image transform unit 12 determines whether or not the two-dimensional display is carried out. In a case where the two-dimensional display is carried out, for example, in a case where the two-dimensional display is instructed from the user or a case where the display apparatus used for the image display does not have the three-dimensional display function, the image transform unit 12 proceeds to step ST16. Also, for example, in a case where the three-dimensional display is instructed from the user or a case where the display apparatus has the three-dimensional display function, the image transform unit 12 proceeds to step ST17.

In step ST16, the image transform unit 12 performs the two-dimensional display processing. Since the three-dimensional display material is a material where the parallax adjustment is not conducted, the image transform unit 12 outputs one of the left view point material and the right view point material of the three-dimensional display material as the two-dimensional display material.

In step ST17, the image transform unit 12 performs the three-dimensional display processing. Since the three-dimensional display material is the material where the parallax adjustment is not conducted, so that the natural and more comfortable three-dimensional display can be carried out, the image transform unit 12 performs the parallax adjustment on the three-dimensional display material. Furthermore, the image transform unit 12 outputs the three-dimensional display material after the parallax adjustment.

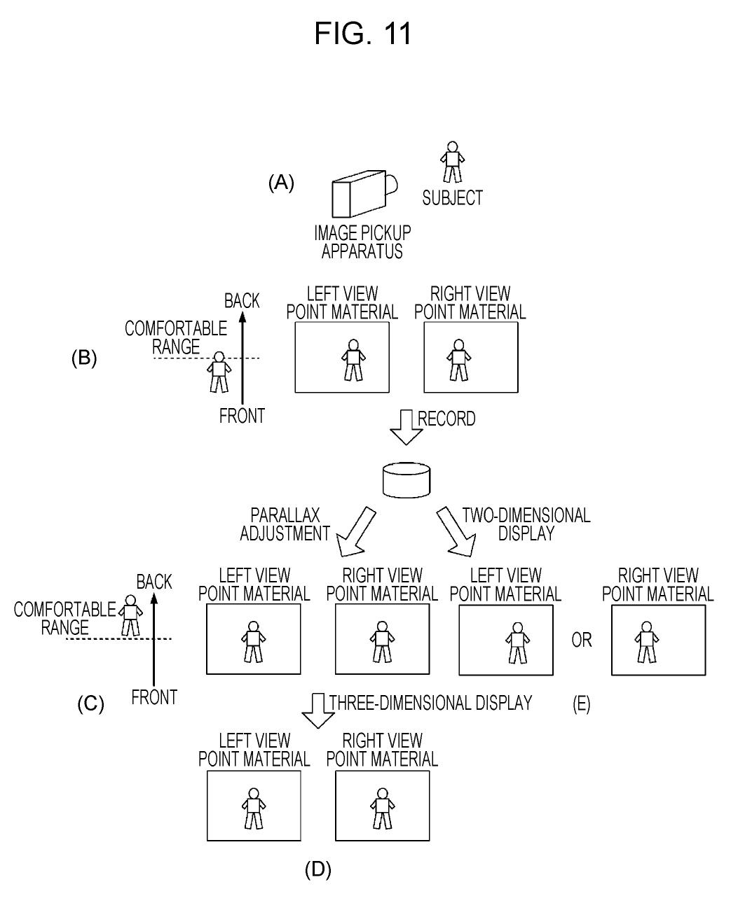

FIG. 11 exemplifies a case where a material before the parallax adjustment is recorded in a recording medium in the second operation by the image processing apparatus. For example, as illustrated in (A) of FIG. 11, an image of a subject is picked up by the image pickup apparatus. The left view point material and the right view point material generated by the image pickup apparatus which are illustrated in (B) of FIG. 11 are recorded, for example, in the recording medium. In the three-dimensional display using the left view point material and the right view point material recorded in the recoding medium, in a case where the subject position is located in front of the comfortable range, the parallax adjustment is conducted on the left view point material and the right view point material, and as illustrated in (C) of FIG. 11, and the position of the subject is moved. By conducting the parallax adjustment in the above-mentioned manner, the subject position is set to be located within the comfortable range. Furthermore, as illustrated in (D) of FIG. 11, the left image is displayed by using the left view point material after the parallax adjustment, and the right image is displayed by using the right view point material after the parallax adjustment. Also, in a case where the two-dimensional display is carried out, as illustrated in (E) of FIG. 11, the two-dimensional display is carried out by using one of the recoded left view point material and the right view point material.

When the above-mentioned processing is conducted, the image processing apparatus 10 can output the material suitable to the two-dimensional display or the three-dimensional display in accordance with whether or not the three-dimensional display material used for the image display is the parallax-adjusted material. Therefore, irrespective of whether or not the three-dimensional display material used for the image display is the parallax-adjusted material, in a case where the three-dimensional display is carried out, the three-dimensional image can be displayed naturally and more comfortably. Furthermore, in a case where the two-dimensional display is carried out, it is possible to avoid a situation in which the still object is displayed with a movement.

### 3. Case of Software Processing

Also, the series of processings described in the specification can be executed by hardware, software, or a composite structure of the both. In a case where the processing is executed by the software, a program where a processing sequence is recorded is installed into a memory within a computer that is incorporated in dedicated-use hardware for execution. Alternatively, the program can also be installed into a general-use computer that can execute various processings for execution.

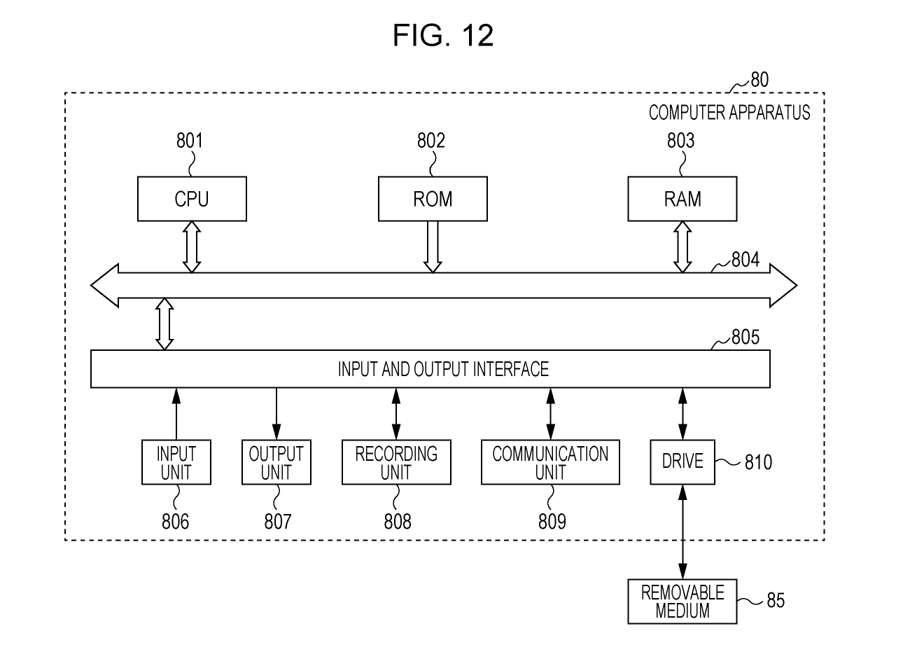

FIG. 12 exemplifies a configuration of a computer apparatus configured to execute the above-mentioned series of processing on the basis of a program. A CPU (Central Processing Unit) 801 of a computer apparatus 80 is configured to execute various processings in accordance with a computer program recorded in a ROM (Read Only Memory) 802 or a recording unit 808.

A RAM 803 (Random Access Memory) appropriately stores a computer program executed by the CPU 801, data, and the like. The CPU 801, the ROM 802, and the RAM 803 are mutually connected by a bus 804.

An input and output interface 805 is also connected to the CPU 801 via the bus 804. An input unit 806 such as a touch panel, a key board, a mouse, and a micro phone and an output unit 807 composed of a display or the like are connected to the input and output interface 805. The CPU 801 executes various processings corresponding to instructions that are input from the input unit 806. Then, the CPU 801 outputs results of the processings to the output unit 807.

The recording unit 808 connected to the input and output interface 805 is composed, for example, of a hard disk and records the computer program executed by the CPU 801 and various pieces of data. A communication unit 809 communicates with an external apparatus by being connected to the internet or a local area network via a wired or wireless communication medium. Also, the computer apparatus 80 may obtain a computer program via the communication unit 809 to be recorded in the ROM 802 or the recording unit 808.

When a removable medium 85 such as a magnetic disc, an optical disc, an opto-magnetic disc, or a semiconductor disc is mounted to a drive 810, the drive 810 drives the removable medium to obtain the recorded computer program, data, and the like. The obtained computer program and data are transferred to the ROM 802, the RAM 803, or the recording unit 808 as appropriate.

The CPU 801 reads out and executes the computer program for carrying out the above-mentioned series of processings, and the above-mentioned series of processings are conducted on the material recorded on the recording unit 808 and the removable medium 85 and the material supplied via the communication unit 809.

It should be noted that the present technology is not to be considered limited to the above-mentioned embodiments. The embodiments of the present technology disclose the present technology by way of exemplifications, and it should be understood by those skilled in the art that various modifications, combinations, sub-combinations and alterations may occur depending on design requirements and other factors insofar as they are within the scope of the appended claims or the equivalents thereof. That is, to determine the gist of the present technology, the scope of the appended claims should be referred to.

Also, the image processing apparatus of the present technology can adopt the following configurations.

(1) An image processing apparatus including: an information obtaining unit configured to obtain parallax adjustment information with regard to a parallax-adjusted three-dimensional display material; and an image transform unit configured to perform an inverse transform processing on the parallax-adjusted three-dimensional display material to be restored to a material before the parallax adjustment on the basis of the parallax adjustment information obtained by the information obtaining unit and generate a two-dimensional display material.

(2) The image processing apparatus according to (1), in which the image transform unit enlarges an image or performs an interpolation processing on an area where the image does not exist to eliminate the area without the existence of the image through the inverse transform processing.

(3) The image processing apparatus according to (2), in which the image transform unit enlarges the image in accordance with an adjustment amount of the parallax adjustment to eliminate the area without the existence of the image.

(4) The image processing apparatus according to (2), in which the image transform unit enlarges the image in accordance with a maximum adjustment amount of the parallax adjustment to eliminate the area without the existence of the image.

(5) The image processing apparatus according to (4), in which the image transform unit enlarges the image in accordance with a maximum adjustment amount of the parallax adjustment for each scene to eliminate the area without the existence of the image.

(6) The image processing apparatus according to any one of (1) to (5), in which in a case where an entire image is shifted in the parallax adjustment, the image transform unit shifts the entire image in an opposite direction in the inverse transform processing.

(7) The image processing apparatus according to any one of (1) to (5), in which in a case where an object is shifted in the parallax adjustment, the image transform unit shifts the object in an opposite direction in the inverse transform processing.

(8) The image processing apparatus according to any one of (1) to (7), in which the information obtaining unit obtains identification information indicating whether or not the three-dimensional display material is the parallax-adjusted material, and in which in a case where a three-dimensional display is carried out, when the identification information obtained by the information obtaining unit indicates that the parallax adjustment is not conducted, the image transform unit performs the parallax adjustment.

The present disclosure contains subject matter related to that disclosed in Japanese Priority Patent Application JP 2012-011063 filed in the Japan Patent Office on Jan. 23, 2012, the entire contents of which are hereby incorporated by reference.

What is claimed is:

1. An image processing apparatus comprising:
an information obtaining unit configured to obtain parallax adjustment information with regard to a parallax-adjusted three-dimensional display material; and
an image transform unit configured to perform an inverse transform processing on the parallax-adjusted three-dimensional display material to be restored to a material before the parallax adjustment on the basis of the parallax adjustment information obtained by the information obtaining unit and generate a two-dimensional display material.

2. The image processing apparatus according to claim 1,
wherein the image transform unit enlarges an image or performs an interpolation processing on an area where the image does not exist to eliminate the area without the existence of the image through the inverse transform processing.

3. The image processing apparatus according to claim 2,
wherein the image transform unit enlarges the image in accordance with an adjustment amount of the parallax adjustment to eliminate the area without the existence of the image.

4. The image processing apparatus according to claim 2,
wherein the image transform unit enlarges the image in accordance with a maximum adjustment amount of the parallax adjustment to eliminate the area without the existence of the image.

5. The image processing apparatus according to claim 4,
wherein the image transform unit enlarges the image in accordance with a maximum adjustment amount of the parallax adjustment for each scene to eliminate the area without the existence of the image.

6. The image processing apparatus according to claim 1,
wherein in a case where an entire image is shifted in the parallax adjustment, the image transform unit shifts the entire image in an opposite direction in the inverse transform processing.

7. The image processing apparatus according to claim 1,
wherein in a case where an object is shifted in the parallax adjustment, the image transform unit shifts the object in an opposite direction in the inverse transform processing.

8. The image processing apparatus according to claim 1,
wherein the information obtaining unit obtains identification information indicating whether or not the three-dimensional display material is the parallax-adjusted material, and
wherein in a case where a three-dimensional display is carried out, when the identification information obtained by the information obtaining unit indicates that the parallax adjustment is not conducted, the image transform unit performs the parallax adjustment.

9. An image processing method comprising:
obtaining parallax adjustment information with regard to a parallax-adjusted three-dimensional display material; and
performing an inverse transform processing on the parallax-adjusted three-dimensional display material to be restored to a material before the parallax adjustment on the basis of the obtained parallax adjustment information and generating a two-dimensional display material.

10. A program for causing a computer to execute an image processing on a three-dimensional display material, the image processing comprising:
obtaining parallax adjustment information with regard to a parallax-adjusted three-dimensional display material; and
performing an inverse transform processing on the parallax-adjusted three-dimensional display material to be restored to a material before the parallax adjustment on the basis of the obtained parallax adjustment information and generating a two-dimensional display material.
